(19) United States
(12) Patent Application Publication
(10) Pub. No.: US 2006/0112212 A1
(43) Pub. Date: May 25, 2006

(54) Virtual machine computer system for running guest operating system on a central processing means virtualized by a host system using region ID virtual memory option

(75) Inventor: Christian Hildner, Nurnberg (DE)

Correspondence Address: BROWDY AND NEIMARK, P.L.L.C.;624 NINTH STREET, NW, SUITE 300, WASHINGTON, DC, 20001-5303, US

(73) Assignee: HOB GmbH & Co. KG, Cadolzburg (DE)

(21) Appl. No.: 10/994,426

(22) Filed: Nov. 23, 2004

(51) Int. Cl. G06F 21/00

(52) U.S. Cl. 711/6

(57) ABSTRACT

The virtual machine system for running computer guest processes on a central processing means 8 virtualized by the virtual machine monitor (VMM) includes a host central processing unit 8 on which a host memory management unit 9 is implemented. The latter has a translation look-aside buffer 13 with a plurality of entries 14 each of which consists of a virtual address value 111, a physical address value 211 and a region identification value 16. The region register 17 in the host CPU 8 contains the region ID 16 of the currently running guest process. The region ID 16 is composed of a guest allocated bit field 18, in which a region sub ID is entered, and a guest system identifier bit field 19, in which an identification value uniquely identifying an associated guest system is entered.

### BACKGROUND OF THE INVENTION

1. Field of the Invention

The invention relates to a virtual machine computer system being capable of running multiple guest operating systems concurrently by virtualization of a host machine. In this connection commonly operating systems of several guests are handled on the hardware of the host machine under the host operating system by means of a so-called virtual machine monitor and using the region ID virtual memory option.

2. Background Art

A computer system generally consists of input/output devices, memory devices and a central processing unit (CPU). In the CPU a memory management unit (MMU) is implemented which in the context of host/guest systems uses the principle of virtual addressing. Actually all current operating systems installed and running on standard CPUs use this principle of virtual addressing to protect the memory of different processes against accesses from outside of the currently running process.

To make use of the virtual addressing facility the MMU has to have a knowledge of both the virtual addresses and the corresponding physical addresses involved in a process, i.e. the MMU disposes of a reference list with a “translation” between each virtual address and each corresponding physical address. One of these translations is always valid for a whole memory area—a so called “memory page”.

The part of the MMU which contains said translations is called translation look-aside buffer (TLB).

To visualize the entries and use of the TLB reference is made to the accompanying drawing of FIG. 1 which shows a system block diagram of a virtual machine system realized by a host computer 3 on which two guest operating systems 1, 2 are to be run in a virtualized computer environment. The host computer 3 commonly comprises a central processing unit (CPU) 8 in which a memory management unit (MMU) 9 already cited above is implemented. Further on the host computer 3 comprises a memory unit with common read-only- and random-access-memories (ROM's and RAM's) cooperating with the CPU 8. The memory unit is mapped into the physical address space 15.

Now as can be seen from FIG. 1 the MMU 9 handles the virtual address spaces 11, 12 of two processes #1 and #2 of the virtualized systems 1 and 2, respectively. Within these virtual address spaces 11, 12 the virtual addresses 111, 112 of the processes #1 and #2 are contained.

In the above mentioned translation look-aside buffer (TLB) 14 of the MMU 9 one can find a number of entries 14.1, 14.2, each of which is filled with a translation for a particular memory page, e.g. for process #1 the entry 14.1 comprises the virtual address 111 and the according physical address 211. Accordingly entry 14.2 comprises the virtual address 112 of the virtual address space 12 of process #2 and the according physical address 212. The same applies for all entries 14n with the n-th entry comprising a virtual address 11n and a physical address 21n. The physical addresses 211, 212, . . . 21n point to the physical address space 15.

In the prior art when the host operating system running on the CPU 8 switches from e.g. process #1 of guest system 1 to process #2 of guest system 2, i.e. the operating system makes a so-called context switch, the TLB 13 is cleared of all translations (virtual address 111, physical address 211) of the first process #1 to ensure that the second process #2 is not able to access data from the first process #1. Processing this clearage and the refill of the TLB is expensive and time-consuming leading to a considerable deterioration of the whole system performance.

To avoid this problem current CPUs use a mechanism to accelerate context switches, which is called virtual region/virtual address space ID/number. To realize this mechanism the TLB entries 14 are added with a further value which is a region identification value (region ID) 16. The operating system running on the CPU 8 of the host computer 3 ensures that to each process #1, #2, . . . #n a region ID 16.1, 16.2 . . . 16.n is assigned which is unique within the computer system. Further on the CPU 8 is provided with a region register 17 which contains the region ID 16 of the process currently running on the CPU 8.

Now in case of a context switch it is only necessary to update the region register 17 with a region ID 16 of the process that has to be run. Doing so only the TLB entries 14 corresponding to the new process are valid and a safe protection against the memory of the other processes is achieved. By means of this virtual region/virtual address space mechanism so called flushes, i.e. clearing translations for virtual addresses, of the TLB 8 can be saved. If one process receives control again it is probable that translations, i.e. TLB entries 14 needed by this process are still available.

In FIG. 1 process #2 of guest system 2 is assumed to be active. In the region register 17 the region ID 16.2 is set. In as much only TLB entry 14.2 whose region ID 16.2 matches the value in the region register 17 is valid and accordingly used by the MMU 9 to translate virtual addresses 112 to according physical addresses 212. When making a context switch to process #1 the value in the region register 17 is amended to region ID 16.1 making the TLB entry 14.2 invalid as its region ID 16.2 does not match to the region ID 16.1 actually held in the region register 17.

In a virtual machine monitor (VMM) 4 environment multiple operating systems (guests) are running concurrently. When running the guest operating systems 1, 2 in a completely virtualized computer environment by the VMM 4, however, the latter regularly has to flush all TLB entries 14 when switching from one guest operating system to another. Otherwise it is not ensured that the memory of one guest operating system does not accidentally be accessed by another guest operating system by using the same region ID in the virtual environment.

### SUMMARY OF THE INVENTION

Starting from the aforementioned problems of the prior art the object of the invention is to provide a virtual machine computer system for running guest operating system processes on a central processing means fully virtualized by the VMM with improved performance by avoiding the necessity to flush all TLB entries when switching from one guest operating system to another.

This object is achieved by a novel structure of the region ID which is composed of on the one hand a guest allocated bit field of a field size less than the maximum field size of the region ID and in which a guest allocated region sub ID is entered by a guest system and on the other hand a guest system identifier bit field in which an identification value uniquely identifying an associated guest system is entered by the VMM. By this structure an overall region ID is created which is unique throughout the overall computer system. This means that no flushing of the TLB 13 is necessary as each region ID is now unambiguously assigned to each virtualized guest system 1, 2.

Further features, details and advantages of the invention are disclosed in the following description in which an embodiment of the subject matter of the invention is described in more detail with reference to the accompanying drawings.

### BRIEF DESCRIPTION OF THE DRAWINGS

FIG. 1 is a block diagram of a virtual machine system,

FIG. 2 A-F are diagrammatic representations of the region register of a processor filled with different region ID's, and

FIG. 3 is a diagrammatic representation of a processor running a host operating system and a WINDOWS guest operating system.

### DETAILED DESCRIPTION OF A PREFERRED EMBODIMENT

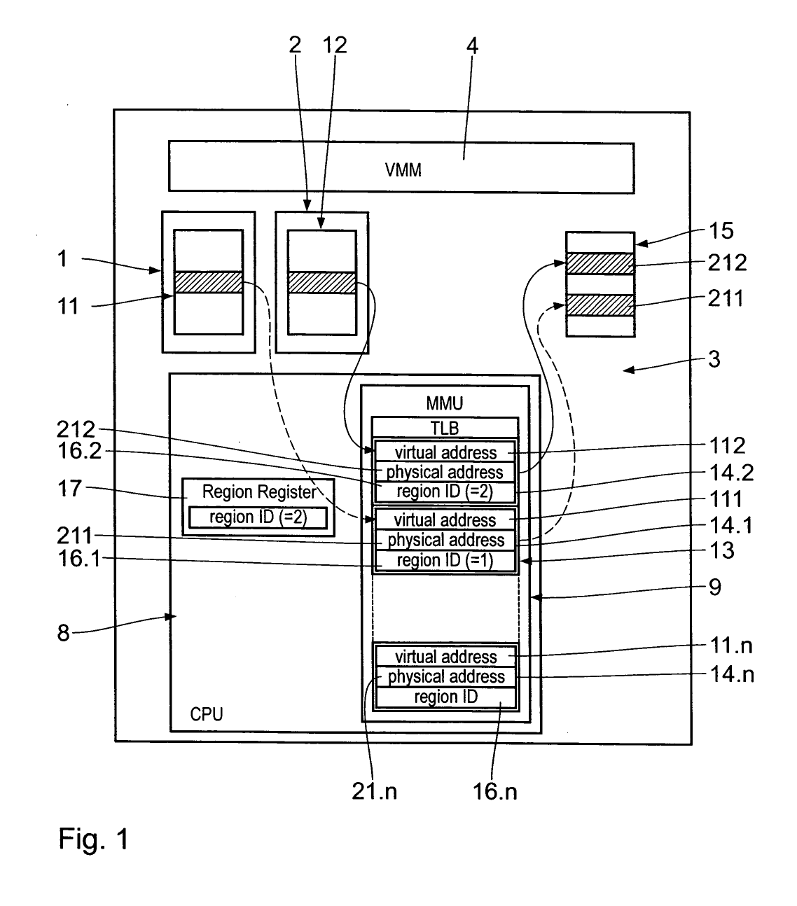

The basic handling of the virtual region/virtual address space concept is fully explained with reference to FIG. 1 in the introducing part of this application and attention is drawn to this description.

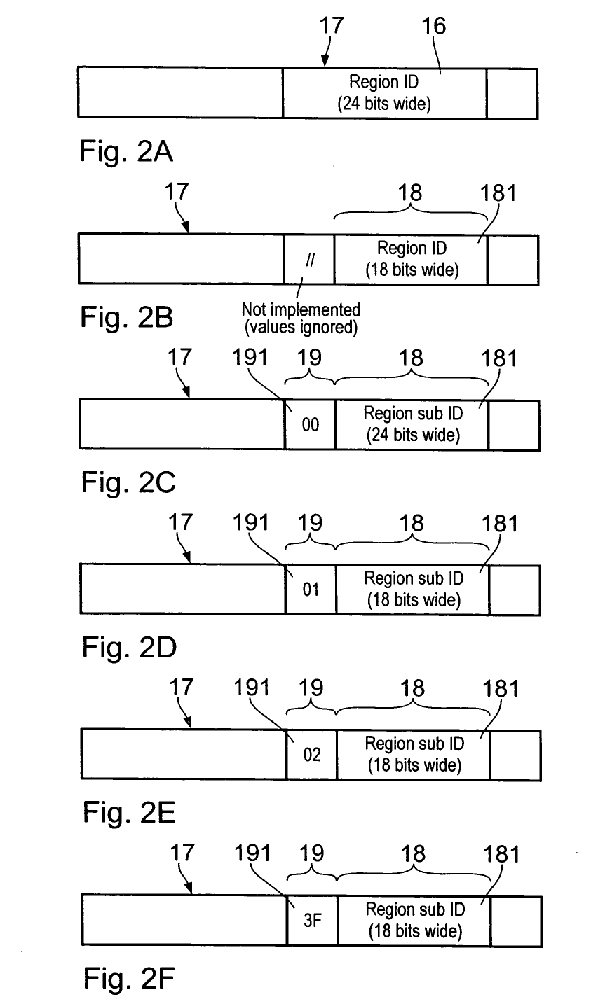

Now in FIG. 2A the complete region register 17 of an Intel® Itanium® IA-64 processor is shown, in which a region ID 16 being up to 24 implemented bits wide can be entered. However, as can be seen in FIG. 2B-F this region ID 16 is divided into a guest allocated bit field 18 which has a field size of 18 bits, what is less than the maximum field size of 24 bits of the region ID 16. Further on the region ID 16 comprises a guest system identifier bit field 19 in which an identification value 191 is entered by the VMM 4 which is uniquely identifying an associated guest operating system. For example in the guest system identifier bit field 19 of FIG. 2D the identification value “01” (denoted with 191) is entered indicating that this region ID is used by the guest operating system 1. In FIG. 2E the identification value “02” is entered in the guest system identifier bit field 19 indicating that this region ID is used by guest operating system 2.

As can be seen by comparing FIG. 2C-F to each other it is irrelevant whether or not the region sub Ids (181) in the guest allocated bit fields 18 are equal or not. In any case due to the different identification values 191 in the bit field 19 the overall region IDs 16 in the region register 17 are different and thus each region ID 16 is unique throughout the overall system for a certain guest process being virtualized on the host CPU 8.

Since the host operating system uses region Ids beginning from around zero in ascending order the value “00” of the guest system identifier is reserved for the host operating system. By doing so the host operating system can use up to 2¹⁸ different region Ids without interfering with the region Ids used for the guest operating systems.

FIG. 2B represents the virtual region register 17 as it is seen from the “view” of a guest. Basically the VMM 4 allocates only the guest allocated bit field 18 to the guest which bit field acts as a virtualized region register. The remaining bits are not implemented for the guest systems and thus ignored.

By running processes in a virtualized environment on Intel® Itanium® processors, e. g. under the Intel® IA-64 process architecture, the number of implemented bits can be found in a returned field named “rid_size” in the return value “vm_info_{—}2” of the function called “PAL_VM_SUMMARY”. Said function is part of the processor abstraction layer PAL which is implemented as firmware for the Intel® Itanium® IA-64 processor. Reference is made to the “Intel® IA-64 architecture software developer's manual volume 2: IA-64 system architecture” revision 1.1, July 2000, pages 11-107, 11-108. By virtualizing this function each guest system 1, 2 only uses the foreshortened maximum field size of the region sub ID which is returned by aforesaid function “PAL_VM_SUMMARY” as an unsigned 8-bit integer denoting the number of bits implemented in the RR.rid field.

With a fully implemented 24 bits wide region register of the host system and a restricted region register given to the guest systems with a region sub ID which is 18 bits wide at maximum 2⁶−1=63 guest systems can be unambiguously served by a host system in a virtualized environment. The subtraction of 1 is based on the fact that one identification value is reserved for the host system (value “00” in the identifier bit field 19 of FIG. 2C).

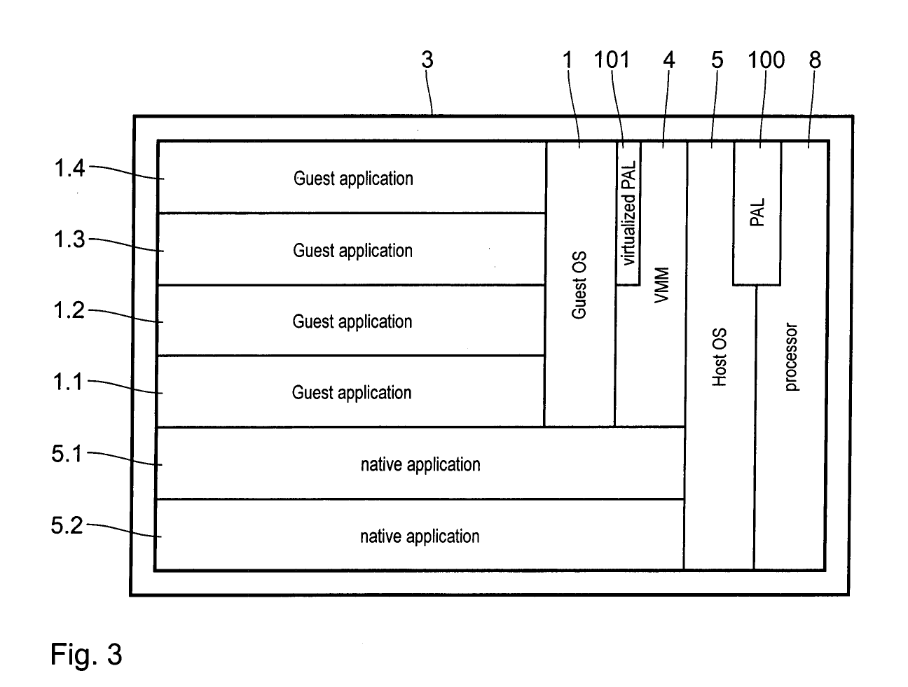

The diagrammatic representation of FIG. 3 shows a CPU 8 of a host computer 3 on which a host operating system 5 is installed and handling native applications 5.1, 5.2. Furtheron a VMM 4 is running on that host operating system 5 to handle e.g. a WINDOWS® guest operating system 1 in a fully virtualized environment. That WINDOWS® operating system 1 runs four WIN 32 applications 1.1, 1.2, 1.3, 1.4.

Under the concept of guest system identifier bit field 19 the identification value 191 of that WINDOWS® guest operating system 1 could be “01” whereas the host operating system 3 carries an identification value 191 of “00”.

The processor abstraction layer PAL of the CPU 8 is denoted as 100 in FIG. 3. An according virtualized processor abstraction layer 101 for the guest operating system 1 is implemented by the VMM 4.

Finally it is to be noted that the VMM 4 may include a host operating system functionality, i.e. the VMM 4 can operate as so-called hostless VMM.

What is claimed is:

1. A virtual machine computer system for running computer guest operating system processes on a central processing means in a virtualized manner comprising
a host central processing unit—host CPU (8)—,
a host memory management unit—host MMU (9)—implemented in the host CPU (8) and including a translation look-aside buffer—TLB (13)—with a plurality of entries (14) each of which consists of a virtual address value (111, 112), a physical address value (211, 212) and a region identification value—region ID (16)—, each region ID (16) having a maximum field size and identifying one process, and
a virtual machine monitor—VMM (4)—for controlling and handling concurrently running guest processes (#1, #2)
a region register (17) in the host CPU (8) containing the region ID (16) of the currently running process,
wherein the region ID (16) is composed of
a guest allocated bit field (18) of a field size less than the maximum field size of the region ID (16) and in which a region sub ID (181) is entered by a guest system, and
a guest system identifier bit field (19) in which an identification value (191) uniquely identifying an associated guest system is entered.

2. A virtual machine computer system according to claim 1, wherein in the guest system identifier bit field (19) an identification value (191) identifying the host system is entered.

3. A virtual machine computer system according to claim 1, wherein the maximum field size of the region ID (16) is 24 bits and of the region sub ID (181) is 18 bits.

4. A virtual machine system computer according to claim 1, wherein the maximum field size of the region sub ID (181) is denoted in a returned information about virtual memory characteristics of the CPU implementation.

5. A virtual machine computer system according to claim 4, wherein said virtual memory information including the maximum field size of the region sub ID (181) is returned to a guest system on demand by an according virtualized function of a firmware layer.

6. A virtual machine system according to claim 5, wherein the virtualized firmware is a processor abstraction layer.

7. A virtual machine system according to claim 1, wherein the VMM 4 includes a host operating system functionality.
